(19) United States
(12) Patent Application Publication
(10) Pub. No.: US 2022/0320555 A1
(43) Pub. Date: Oct. 6, 2022

(54) Fuel Cell Generator with Cryogenic Compression and Co-Generation of Liquefied Air

(71) Applicant: Jay Stephen Kaufman, Kingston, NH (US)

(72) Inventor: Jay Stephen Kaufman, Kingston, NH (US)

(21) Appl. No.: 17/218,463

(22) Filed: Mar. 31, 2021

(51) Int. Cl. H01M 8/0606; H01M 8/0432; F25J 1/00; F25J 1/02

(52) U.S. Cl. CPC H01M 8/0606; H01M 8/0435; H01M 8/04343; F25J 1/0012; F25J 1/0221; F25J 1/0228; F25J 1/0282; H01M 8/04029

(57) ABSTRACT

The present invention provides a high efficiency prime mover with phase change energy storage for distributed generation and motor vehicle application. Phase change storage minimizes energy required for refrigerant liquefaction while reducing fuel consumption and emissions.

### FIELD OF THE INVENTION

The present invention relates generally to distributed generation and motor vehicle prime movers, and specifically to those using liquid air or oxygen for cryo-cooled air compression.

### BACKGROUND

Since the 1970's a high efficiency prime mover with renewable energy storage has been a goal of motor vehicle and distributed electric generation design to provide energy independence, conserve fossil fuels, and reduce emission of combustion products. This has led to an increased need for clean and reliable energy storage devices, which can store the power generated, and make it readily available when needed in a wide range of applications. As fossil fuels are consumed more rapidly than they can be produced, an “energy crisis” has emerged and there is a widely recognized need to develop new energy technologies. Moreover, the products of combustion are both unhealthy and dangerous for the environment, while the gradual increase in temperature of the earth's atmosphere, or “greenhouse effect,” advises development of energy technology that minimizes the release of heat and greenhouse gases. Some examples of technologies that exploit natural “clean” energy sources include solar photo-voltaic panels, wind turbines, motor vehicle regenerative braking, and fuel cells. Other, yet undeveloped technologies, include structure and motor vehicle draft recovery, advanced refrigerant liquefaction for heat sink cooling, and application of synfuel gasification to production of hydrogen and cryo-sink refrigerant.

Energy storage of solar, wind, and other intermittent sources has in general, been dominated by advanced batteries. Batteries are resource intensive to manufacture; have a limited number of charge cycles; and present an unprecedented fire hazard. Other storage concepts under development, such as super capacitors, flywheels, and compressed air are too expensive, hazardous, and/or inefficient. Renewable fuels, such as compressed hydrogen, liquid natural gas, and bio-fuels are useful for extended unavailability of intermittent energy sources, but are in limited use. Hydrogen is produced inefficiently by electrolysis of water or steam reforming of methane from natural gas, which is available via the environmentally controversial fracking process. Because hydrogen is burned in inefficient converters, on-board vehicle storage is problematic and high pressures must be employed. While carbon from production of synthetic fuels may be captured for sequestration, combustion of these fuels normally discharges carbon dioxide to the atmosphere.

Phase change of liquid air or nitrogen is a promising alternative storage means, for both electric generation and motor vehicles. Specific storage capacity is equal to fuel saved due to cryo-compression per unit weight or volume of refrigerant plus container. The liquid or solidified gas is referred to hereinafter as heat sink refrigerant produced by refrigerant liquefaction. A “liquid nitrogen economy” has been proposed [Kleppe, J. and Schneider, R., “A Nitrogen Economy,” ASEE, 1974] and some high pressure engines with phase change storage using cryogenic compression have been tested. These include a fired turbine [Kishimoto, K. et-al, “Development of Generator of Liquid Air Storage Energy System,” Mitsubishi Tech. Review Vol. 35-3, 1998] and two fuel-less reciprocating engines [Knowlen, C. et-al, “High Efficiency Energy Conversion Systems for Liquid Nitrogen Automobiles,” U. of Washington, SAE 981898,1998] and [Ordonez, C. et-al, “Cryogenic Heat Engine for Powering Zero Emission Vehicles,” ASME Intl. Mech. Engineering Congress & Expo., 2001]. More recently, phase change storage is gaining acceptance in the United Kingdom as indicated by an operating 300 kW pilot plant and a fuel-less liquid nitrogen engine for compact urban vehicles [Center for Low Carbon Futures, “Liquid Air in the Energy and Transport Systems,” ISBN:978-0-9575872-2-9, 2013]. In these prime movers, low compression work is attained by incompressible working fluid. Consumption of refrigerant is excessive in these high pressure engines (40 to 80 bar), which are not optimized, nor supplemented by recovered energy. Two improved cryo-compression engines have been proposed. These are a closed cycle with ambient heat source and quasi-isentropic cryo-compression sink [Ordonez, C., “Liquid Nitrogen Fueled, Closed Brayton Cycle Cryogenic Heat Engine,” Energy Conversion & Management 41, 2000], and an open cycle with over ambient heat source and quasi-isothermal cryo-compression sink as disclosed in the inventor's U.S. Pat. No. 7,854,278. Both concepts would economize refrigerant consumption and profoundly impact design and production capacity of refrigerant condensation facilities.

Refrigerant liquefaction to supply early stage cryo-compression engines is primarily by various standard expansion-cooling cycles. These are powered primarily from the electric grid at low cost off-peak time. Inherent disadvantages of this power source include transmission loss; transport of the refrigerant; and perpetuation of the environmental downside of centralized fossil fuel and nuclear use. Large central expansion-cooling liquefiers are attaining efficiency of about 50%. This requires complex equipment with features, however, such as pre-cooling, multi-stage expansion, and sub-cooling to a lower temperature sink, such as with liquid natural gas during distribution. These features are not economical in smaller distributed applications, leading to higher liquefier power requirements. On-board motor vehicle refrigerant liquefaction is considered to be impractical due to low liquefaction efficiency.

It is important to minimize refrigerant consumption. Moreover, it is recognized that advanced liquefier concepts are required for smaller scale distributed use in conjunction with universally available renewable energy to drive refrigerant liquefaction in both stationary and motor vehicle application. Two promising prior art liquefiers with application to cryo-compression engines are under development. These are magneto-caloric refrigeration, [Matsumoto, K. et al, “Magnetic Refrigerator for Hydrogen Liquefaction,” J. of Physics: Conf. Series 150, 2009], and thermo-acoustic refrigeration [Wollan, J. et al, “Development of a Thermoacoustic Natural Gas Liquefier,” Los Alamos Natl. Lab., LA-UR-02-1623, AlChE, 2002]. An undeveloped prior art liquefier concept is sub-cooling of an air liquefier by available cryo-liquid from a gasifier, as disclosed in the inventor's U.S. Pat. Nos. 10,343,890 and 10,384,926, for examples, or liquefied natural gas facility during vaporization for distribution. Prior art renewable energy power sources adaptable to refrigerant liquefaction for general use include solar, wind, process heat, and pressure recovery. Motor vehicle regenerative braking due to deceleration is a developed technology, potentially supplemented by photo-voltaic solar recovery, for on-board liquefaction. Regenerative braking potential is partially lost due to compression heating in reciprocating engines. Solar recovery to motor vehicles is limited by available capture area and photo-voltaic panel efficiency. Three undeveloped prior art liquefier power source concepts are energy recovery of wind, motor vehicles, and fuel synthesis for distributed and mobile applications, as disclosed in the inventor's U.S. Pat. Nos. 9,395,118; 7,854,278; and 10,343,890, respectively.

### SUMMARY OF INVENTION

The present invention is a cryo-compression fuel cell generator with energy recovery (hereinafter “engine”). The fuel cell generator and associated gas expander generator, as provided herein, supply product electricity to external electric load and a portion to meet internal engine requirements. Fuel cells are a stack of numerous smaller cells with tenuous electrical connections, sensitive to thermal stresses induced by transients (load changes). This issue has retarded fuel cell deployment, especially in motor vehicle operation, which is almost entirely transient. Shifting fuel cell electric load to an air liquefier will enable generally constant (steady state) operation of the fuel cell. This requires fuel feed to the fuel cell during liquefier operation. However, extra fuel consumption by the fuel cell will be made up by lower fuel consumption in combustion engines using the liquid air.

In its most basic form, the engine of the present invention includes a liquefier compressor, an aftercooler, a cryo-fluid supply, an air pre-heater, a fuel cell generator, and a means for driving the liquefier compressor. It is understood that the means for driving the liquefier compressor may be mechanically driven by steam or electrically driven by electricity or both. When the means are electrical, the electricity may be generated within the engine itself or the electricity may be sourced externally from the engine. Electricity sourced externally from the engine is referred to herein as “external electricity.” It is understood that a “fluid” may be a liquid or gas and may change states therebetween within sections of the engine.

The liquefier compressor takes in air from outside of the engine, or “atmospheric air,” and compression heats it. As discussed in detail below, the liquefier compressor may, for one example, be steam expansion driven, which may require supplemental electric drive. It may also, for a second example, be a liquefier motor compressor. One of at least ordinary skill in the art will recognize that these are but two examples of possible liquefier compressors that may be successfully deployed in the engine of the present invention.

The fuel cell generator includes a cathode channel, an anode channel, a solid state electrolyte disposed therebetween, and a fuel supply. The fuel supply supplies a fuel, which is preferably hydrogen. Hereinafter, the fuel will be referred to as the preferred hydrogen or hydrogen fuel, but it is understood that other fuels may be substituted. The fuel cell generator generates electricity through chemical reaction.

A cathode reduction reaction occurs in the cathode channel. The cathode channel is provided with cathode intake air and produces negative oxygen ions and oxygen depleted air. Cathode intake air is simply air that has circulated in the engine to eventually be provided to the cathode channel as a reagent. The negative oxygen ions pass through the solid state electrolyte. The oxygen from the reagent cathode intake air has been reduced to the negative oxygen ions so that the remaining product is the air without the ionized oxygen, or “oxygen depleted air.”

An anode oxidation reaction occurs in the anode channel. The anode channel is provided with oxygen ions that have passed from the cathode channel through the solid state electrolyte and hydrogen from the fuel/hydrogen supply and produces anode steam and residual hydrogen. Again, anode steam is simply steam that has been produced in the anode channel. It is assumed that the more abundant reagent in the oxidation reaction is the hydrogen fuel, so that residual hydrogen will be expelled out of the anode channel after all of the oxygen has reacted with the hydrogen to form the anode steam.

The solid state electrolyte is preferably yttria stabilized zirconia. One of at least ordinary skill in the art will recognize that other solid state electrolytes may be successfully substituted. Each of these possible substitutions is considered to be within the scope of the present invention.

The air pre-heater heats cathode intake air on its way to the cathode channel. It is understood that the air pre-heater is one of several devices in the engine of the present invention that has heat exchange properties. In other words, the air pre-heater provides heat to the cathode intake air and that heat was provided from another fluid provided to the air pre-heater from another engine component. For any engine component, such as the air pre-heater, that has heat exchange properties, it is understood that while two or more fluids may be provided to that component, it is not necessarily for the purposes of a chemical reaction. Instead, a warmer fluid will pass through the component from one direction; a cooler fluid will pass through the component from another direction; and the component will use its heat exchange properties to transfer some of the heat from the warmer fluid to the cooler fluid. Again, the fluids themselves likely do not mix within such components, but the heat of one is transferred to the other.

As examples, and discussed below in more detail, there are first, second, and third main embodiments of the engine of the present invention. In the first embodiment, anode steam, combustion product steam, and oxygen depleted air from a superheater provide heat to the air pre-heater, which the air pre-heater then provides to the cathode intake air. In the second embodiment, the anode steam and residual hydrogen products from the anode channel provide heat to the air pre-heater, which the air pre-heater then provides to the cathode intake air. In the third embodiment, anode steam, combustion product steam, and oxygen depleted air from a gas expander generator provide heat to the pre-heater, which the air pre-heater then provides to the cathode intake air. Each of these embodiments will be described in more detail below. When a fluid can move between components, for either heat exchange, chemical reaction, or mechanical purposes, those components are said to be in fluid communication with one another.

The aftercooler is another component with heat exchange properties. The aftercooler is in fluid communication with the air pre-heater, the liquefier compressor, and the cryo-fluid supply. The liquefier compressor has compression heated atmospheric air, which it then provides to the aftercooler in the form of heated air. That heat will be provided to cathode intake air. As discussed above, that cathode intake air is then further heated in the air pre-heater before it is provided to the cathode channel of the fuel cell generator. The provision of heat to the cathode intake air results in the cooling of the heated air from the liquefier compressor to ambient air. This ambient air is provided to the cryo-fluid supply.

The cryo-fluid supply is a circuit that begins and ends with the aftercooler. The cryo-fluid supply includes at least a fluid liquefier, a liquid fluid dewar, and a liquid fluid feed pump. In the first and third embodiments, the fluid is air so that the cryo-fluid supply is a cryo-air supply; the fluid liquefier is an air liquefier; the liquid fluid dewar is a liquid air dewar; and the liquid fluid feed pump is a liquid air feed pump. In the second embodiment, the fluid is a mixture of air and oxygen so that the cryo-fluid supply is a cryo-oxygen/air supply; the fluid liquefier is an oxygen/air liquefier; the liquid fluid dewar is (as in the first and third embodiments) a liquid air dewar; and the liquid fluid feed pump is a liquid oxygen feed pump.

The aftercooler provides the fluid liquefier with the ambient air. Although in general, the fluid liquefiers have an internal heat exchanger, the fluid liquefier as a whole is not a heat exchanger, so providing the ambient air to the fluid liquefier is for the purpose of the phase change from gas to liquid. In some embodiments, as discussed below, another heat exchanging engine component may be disposed between the aftercooler and the fluid liquefier, so the provision of the ambient air from the aftercooler to the fluid liquefier may be direct or indirect via another component.

In the first and third embodiments, the air liquefier liquefies the cooled air and provides at least a portion of the liquid air to the liquid air dewar for storage. In these embodiments, at least a second portion of the liquid air is pumped back to the aftercooler with the liquid air feed pump. Preferred versions of the first and third embodiments include a liquid air extraction valve that controls a flow of the liquid air from the air liquefier to the liquid air dewar and the liquid air feed pump. As will be discussed below, in these embodiments, it is preferred that the liquid air not be pumped directly back to the aftercooler, but rather through one or more components.

In the second embodiment, the oxygen/air liquefier liquefies the cooled air from the aftercooler into liquid air and liquid oxygen. The liquid air is provided to the liquid air dewar for storage. It is preferred that a liquid air extraction valve be included between the oxygen/air liquefier and the liquid air dewar so as to control the flow of the liquid air. The liquid oxygen is then pumped directly back to the aftercooler by the liquid oxygen feed pump. Preferred versions of the third embodiment include an external oxygen valve connected to the liquid oxygen feed pump. Oxygen from a source outside of the engine, or “external oxygen” may be provided to the cryo-oxygen/air supply through an oxygen valve connected to the liquid oxygen feed pump.

Whether liquid air is pumped indirectly back to the aftercooler as in the first and third embodiments, or liquid oxygen is pumped directly back to the aftercooler as in the second embodiment, the fluid provides the aftercooler with a heat sink so that heat may be drawn from the heated air provided to the aftercooler from the liquefier compressor.

As discussed briefly above, there are several means for driving the liquefier compressor. In the first embodiment, the means for driving the liquefier compressor is a water-steam circuit that includes a hybrid expander-electric compressor drive mechanically engaged with the liquefier compressor such that the steam that drives the hybrid expander-electric compressor drive also indirectly drives the liquefier compressor. The means in the first embodiment may also include external electricity to the liquefier compressor. In the second embodiment, the means for driving the liquefier compressor is also a water-steam circuit, but one that includes a steam turbine generator that is in electrical communication with the liquefier compressor. This electrical communication is such that the electricity generated by the steam turbine generator from the steam circulating within the water-steam circuit is provided to the liquefier compressor. The means in the second embodiment may also include electricity generated by the fuel cell generator. In the third embodiment, the means for driving the liquefier compressor is a gas expander generator in electrical communication with the liquefier compressor such that the gas expander generator provides its generated electricity to the liquefier compressor. The means in the third embodiment also preferably include a vehicle deceleration recovery generator in electrical communication with the liquefier compressor. The vehicle deceleration recovery generator generates electricity from vehicle deceleration. The means in the third embodiment may also include electricity generated by the fuel cell generator. Each of these variations will be discussed in detail below.

In the first and second embodiments, the means for driving the liquefier compressor is a water-steam circuit. As discussed above, in the first embodiment, the water-steam circuit includes a hybrid expander-electric compressor drive that is driven by steam and in the second embodiment, the water-steam circuit includes a steam turbine generator that generates electricity from the circulating steam. As each of the hybrid expander-electric compressor drive and the steam turbine generator is a driver of the liquefier compressor and as these components are the main differences in the different versions of the water-steam circuit, these components are referred to generically as a driver. The water-steam circuit includes a driver, a condenser, a water feed pump, a feedwater heater, a solar evaporator, and a superheater.

As suggested by the label, water-steam circuit, water circulates through this circuit both as steam and condensate. Also as suggested by the label, a starting point within the components is largely arbitrary. It is therefore understood that the order in which the components are discussed herein does not necessarily denote a chronological order. The driver expels extraction steam and circulating steam. Extraction steam and circulating steam are both regular steam but have been labeled differently to indicate that they are two portions of the steam created by the driver's operation and that they go in different paths from the driver. The circulating steam is provided to the condenser. The condenser includes a heat exchanger and a steady supply of cooling water. Heat from the circulating steam is drawn into the cooling water without the circulating steam coming in contact with the cooling water. As heat is drawn from the circulating steam, it condenses into condensate, which is fed into the water feed pump. The water feed pump then pumps the condensate into the feedwater heater. The extraction steam from the driver is provided to the feedwater heater. The feedwater heater has heat exchange properties so that the heat from the extraction steam is transferred to the condensate. The heated condensate is further heated back into circulating steam by solar radiation in the solar evaporator. The circulating steam is heated still further in the superheater and the superheater provides the superheated steam to the driver. The superheater also has heat exchange properties. In the first embodiment, the heat used in the superheater to superheat the circulating steam is provided by anode steam, combustion product steam, and oxygen depleted air from a gas expander generator, discussed below. In the second embodiment, the heat used in the superheater to superheat the circulating steam is provided by oxygen depleted air from a cathode exhaust circulator, also discussed below. In preferred embodiments, especially the first embodiment, the water-steam circuit also includes a heat storage unit that stores excess solar insolation.

In preferred embodiments of the present invention, specifically the first and third embodiments, the cryo-air supply also includes a cryo-recuperator and a cryo-compressor. As suggested above, the cryo-recuperator is disposed between the aftercooler and the air liquefier. The aftercooler provides the ambient air to the cryo-recuperator. The cryo-recuperator has heat exchange properties so that the ambient air is further chilled to sub-ambient air. Again, designations such as “heated air,” “ambient air,” “sub-ambient air” are all referring to the same air but at different temperatures and in different positions within the engine. The sub-ambient air is provided to the air liquefier, which has to do less work to liquefy the air because more heat has been removed from it than if the ambient air had come directly from the aftercooler.

The air liquefier provides an air vapor portion of the sub-ambient air to the cryo-compressor. Liquid air is also pumped from the liquid air feed pump to the cryo-compressor. The cryo-compressor then compression heats the sub-ambient air/liquid air combination, emerging from the cryo-compressor as cathode intake air. The cathode intake air then gains heat in the cryo-recuperator, the aftercooler, and the air pre-heater before it is provided to the cathode channel for reaction. In both the first and third embodiments, the fuel cell generator is in electrical communication with at least the cryo-compressor so that the fuel cell generator provides electricity to the cryo-compressor.

Preferred embodiments of the engine of the present invention, specifically the first and third embodiments, include a burner and a gas expander generator. The burner is a fuel burner and preferably a hydrogen fuel burner. The burner is in fluid communication with the cathode channel of the fuel cell generator such that the oxygen depleted air from the cathode channel is provided to the burner. The burner is also in fluid communication with the anode channel of the fuel cell generator such that the anode steam and residual hydrogen fuel from the anode channel are provided to the burner. In the third embodiment, auxiliary fuel, which is preferably a non-carbon liquid fuel, is also provided to the burner from an auxiliary fuel supply. The auxiliary fuel is preferably pumped from the auxiliary fuel supply to the burner. Regardless of the inclusion or exclusion of the auxiliary fuel, the burner burns the hydrogen fuel to produce combustion product steam, which is provided along with the anode steam and the oxygen depleted air to the gas expander generator.

The combustion product steam, anode steam, and oxygen depleted gas expand in the gas expander generator, creating electricity. The gas expander generator may be in electrical communication with the liquefier compressor so that the generated electricity is a means for driving the liquefier compressor, as in the third embodiment. As in both the first and third embodiments, the gas expander generator is preferably also in electric communication with the cryo-compressor so that the gas expander generator provides electricity to the cryo-compressor.

In the first embodiment, the gas expander generator is in fluid communication with the superheater of the water-steam circuit so that heat from the combustion product steam, anode steam, and oxygen depleted air provide heat to the superheater, which is used to superheat the circulating steam within the water-steam circuit. In the third embodiment, the gas expander generator is in fluid communication with the air pre-heater so that heat from the combustion product steam, anode steam, and oxygen depleted air provide heat to the air pre-heater, which is used to heat the cathode intake air on its way to the cathode channel of the fuel cell generator.

Preferred embodiments of the engine of the present invention, specifically the second embodiment, also include a cathode exhaust circulator, an anode exhaust drive, a fuel separator, and an oxygen mixing junction. The cathode exhaust circulator is in fluid communication with the cathode channel of the fuel cell generator such that the fuel cell generator provides its oxygen depleted air to the cathode exhaust circulator. The cathode exhaust circulator is also in fluid communication with the superheater of the water-steam circuit such that heat from the oxygen depleted air is provided to the circulating steam in the water-steam circuit through the superheater. The oxygen depleted air, now cooled from having passed through the superheater, is then provided to the oxygen mixing junction. Oxygen vapor from the aftercooler is also provided to the oxygen mixing junction. The oxygen depleted air and the oxygen vapor are mixed at the oxygen mixing junction and then proceed to the air pre-heater. Anode steam and residual hydrogen from the air pre-heater are provided to the anode exhaust drive and then to the fuel separator. The anode exhaust drive is driven by the anode steam and residual hydrogen fuel from the air-pre-heater. The anode exhaust drive and cathode exhaust circulator are in mechanical communication, so that the anode steam and residual hydrogen fuel also indirectly drives the cathode exhaust circulator. The anode exhaust drive is in electrical communication with the fuel cell generator, which provides electricity to the anode exhaust drive. The fuel separator is preferably a hydrogen separator that separates the anode steam from the residual hydrogen fuel. The anode steam is expelled in the form of anode condensate and the separated hydrogen fuel is provided back to the hydrogen fuel supply.

In summary, in its most basic form, the engine of the present invention includes a liquefier compressor; an aftercooler; a cryo-fluid supply including a fluid liquefier, a liquid flow dewar, and a liquid fluid feed pump; an air pre-heater; a fuel cell generator including a cathode channel, an anode channel, a solid state electrolyte therebetween, and a fuel supply; and means for driving the liquefier compressor, where it is understood that the liquefier may be “driven” mechanically by steam or electrically.

There are three main embodiments of the engine of the present invention. While one of at least ordinary skill in the art will recognize that some features of the main embodiments may be substituted, these are the preferred versions. In the first embodiment, the means for driving the liquefier compressor is a water-steam circuit that includes a hybrid expander-electric compressor drive in mechanical communication with the liquefier compressor, a condenser that is provided with cold water as a heat sink, a water feed pump, a feedwater heater, a solar evaporator, a superheater, and a heat storage unit. The cryo-fluid supply is a cryo-air supply including a cryo-recuperator, an air liquefier, a liquid air dewar, a liquid air feed pump, and a cryo-compressor. The fuel in the fuel supply of the fuel cell generator is hydrogen. The first embodiment also includes a hydrogen burner and a gas expander generator. Further means for driving the liquefier compressor include external electricity. Electricity generated by the fuel cell generator and the gas expander generator is provided to the cryo-compressor of the cryo-air supply.

In the second embodiment, the means for driving the liquefier compressor is also a water-steam circuit with supplemental electricity from the fuel cell generator. The water-steam circuit in the second embodiment includes a steam turbine generator in electrical communication with the liquefier compressor, a condenser that is provided with cold water as a heat sink, a water feed pump, a feedwater heater, a solar evaporator, and a superheater. The cryo-fluid supply is a cryo-oxygen/air supply that includes an oxygen/air liquefier, a liquid air dewar, and a liquid oxygen feed pump. The fuel in the fuel supply of the fuel cell generator is hydrogen. The second embodiment also includes a cathode exhaust circulator, an anode exhaust drive, a residual hydrogen fuel separator, and an oxygen mixing junction.

The third embodiment is envisioned for use in a motor vehicle. In the third embodiment, the means for driving the liquefier compressor are electricity from the fuel cell generator, electricity from a gas expander generator, and electricity from a vehicle deceleration recovery generator. The cryo-fluid supply is a cryo-air supply including a cryo-recuperator, an air liquefier, a liquid air dewar, a liquid air feed pump, and a cryo-compressor. The fuel in the fuel supply of the fuel cell generator is hydrogen. The third embodiment also includes a hydrogen burner and a gas expander generator. The burner is provided with auxiliary fuel that is a liquid non-carbon fuel from an auxiliary fuel supply.

The present invention also includes a method for operating a fuel cell system with co-generation means. The fuel cell system may be any of those described above, where shifting of the fuel cell electric load to the fluid liquefier during reduced fuel cell electric load demand maintains relatively constant fuel cell output to extend the fuel cell life via reduced thermal transients and associated stresses. The steps of the method include maintaining constant electricity generation in a fuel cell for an application requiring electricity; determining a time of reduced demand for the electricity generated in the last step; providing excess generated electricity during the time of reduced demand to a fluid liquefier; and producing liquid fluid. As used herein the term “maintaining constant electricity generation” does not mean perfectly constant, as in with zero fluctuations, but relatively constant with no large upward or downward spikes in output. The step of determining a time of reduced demand may be performed directly by the system through sensors or may be programmed. The time of reduced demand may fluctuate as far as how much the demand is reduced. In other words, if 100% of the electricity generated is required for the original application, then it is not a time of reduced demand. At any other time, however, if the original application requires less than 100% of the electricity generated, then it is determined to be a time of reduced demand and the difference or the “excess generated electricity” is diverted to the fluid liquefier. As described above, the fluid liquefier may be an air liquefier, as in the first and third embodiments described above, or an air and oxygen liquefier, as in the second embodiment. Consequently, the liquid fluid may be either liquid air or a combination of liquid air and liquid oxygen.

The object of the present invention is, therefore, to provide a high efficiency prime mover with phase change energy storage for distributed generation and motor vehicle application. Phase change storage minimizes energy required for refrigerant liquefaction while reducing fuel consumption and emissions.

It is a further object of the present invention to provide cryo-compression to deliver fuel cell intake air to a fuel cell and expansion engine to minimize compression work.

It is a further object of the present invention to provide quasi-steady state fuel cell operation by shift of fuel cell output from fuel cell electric load to an air liquefier to minimize fuel cell thermal transients, thus extending fuel cell life.

It is a further object of the present invention to provide station air liquefier power sources including shifted fuel cell electric output and steam generated by recovered heat plus solar evaporation.

It is a further object of the present invention to provide motor vehicle air liquefier power sources including shifted fuel cell electric output and recovery of vehicle deceleration energy.

It is a further object of the present invention to provide liquid oxygen and recirculation of fuel cell exhaust to enable a small turbine in a fuel cell heat recovery circuit.

It is a further object of the present invention to provide recovery of air liquefier compression to pre-heat fuel cell intake air.

It is a further object of the present invention to provide auxiliary carbon free fuel to minimize hydrogen storage in motor vehicle applications.

The preferred embodiment of the present invention is based on production and use of liquefied refrigerant to reduce air compression work of a combined fuel cell and expansion engine (gas turbine or reciprocating expander) prime mover.

It is a further aspect of this invention to utilize solar and other recovered energy for heat sink refrigerant production to an air liquefier.

These aspects of the invention are not meant to be exclusive and other features, aspects, and advantages of the present invention will be readily apparent to those of ordinary skill in the art when read in conjunction with the following description, accompanying figures and claims.

### DRAWING FIGURES

FIG. 1 is a schematic illustrating a combined fuel cell and gas expander prime mover with a liquid air heat sink and a steam-electric driven air liquefier.

FIG. 2 is a schematic illustrating a fuel cell prime mover with heat recovery, a liquid oxygen heat sink, and an electric-driven oxygen/air liquefier.

FIG. 3 is a schematic illustrating a combined fuel cell and gas expander prime mover with a liquid air heat sink, an all-electric driven air liquefier, and an auxiliary fuel supply.

FIG. 4 is a flow chart depicting the steps of the method of the present invention.

### DETAILED DESCRIPTION

As a preface, it should be noted that all physical components are referred to with an even reference number and all fluid compounds that move amongst the physical components are referred to with an odd reference number. Components with heat exchange properties are depicted as bisected boxes, generally depicting hot and cold sides. It will be understood from the description that these components gain heat from one fluid and provide that heat to another fluid, where the fluids are not likely to mix. Lines indicating an electrical communication are included between relevant components and do not include reference numbers. This is as opposed to lines between components where an arrow is labeled with a reference number, which indicates a specific fluid and that fluid's direction. Finally, it is noted that when a specific model or distributor of a system component is included, this inclusion is merely exemplary and comparable components may be substituted. In addition, one of at least ordinary skill in the art will recognize that alternate fluids may be substituted.

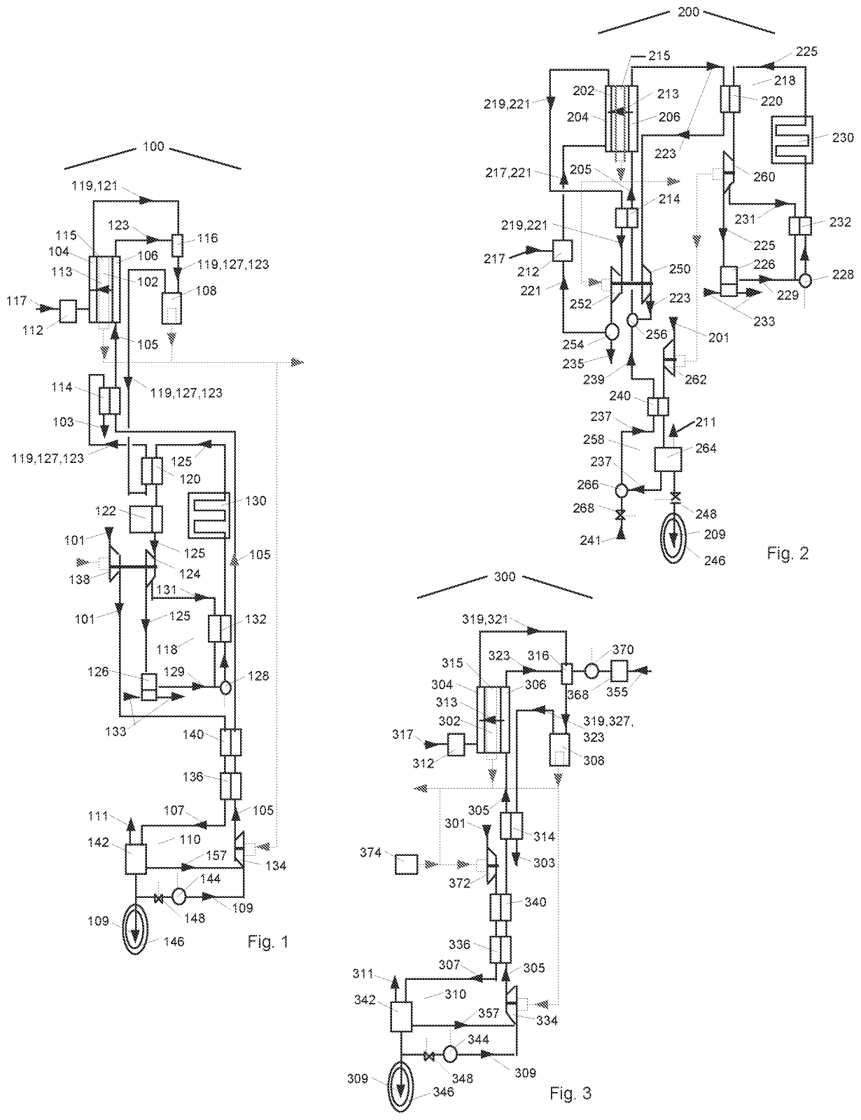

Referring first to FIG. 1, a schematic illustrating a preferred embodiment of the present invention of a fuel cell/gas expander system 100 is provided. System 100 is the preferred version of the first embodiment, discussed above. System 100 includes combined electrical output in conjunction with steam-electric driven air liquefaction. A fuel cell generator 102 generates electricity by chemical reaction while additional electric output is generated from pressurized fuel cell exhaust at high temperature via a positive displacement gas expander generator 108, such as a piston engine.

System 100 includes a fuel cell generator 102 with an anode channel 104 and a cathode channel 106; a gas expander generator 108; a cryo-air supply 110; a fuel supply 112; an air pre-heater 114; a hydrogen burner 116; and a water-steam circuit 118. Gas expander generator 108 provides heat to water-steam circuit 118. Water-steam circuit 118 includes a superheater 120 with a heat storage unit 122; a hybrid expander electric compressor drive 124; a condenser 126; a water feed pump 128; a solar evaporator 130; and a feedwater heater 132. Cryo-air supply 110 includes a cryo-compressor 134; a cryo-recuperator 136; a liquefier compressor 138, with steam expansion and supplemental electric motor drive; an aftercooler 140; and an air liquefier 142 with a liquid air feed pump 144, a liquid air dewar 146, and a liquid air extraction valve 148.

Composition of the fuel cell working fluid varies through system 100 from atmospheric intake air 101 to exhaust 103. Circulation of air, fuel, and products of reaction is described, as follows. Intake air 101 is compression heated in compressor 138 and then cooled to ambient in aftercooler 140, which recovers heat to pre-heat cathode intake air 105, which is air that will be used as a reagent in cathode channel 106. As used herein, it is understood that “cathode intake air” is air that will be used as a reagent in cathode channel 106 and is labeled differently only to distinguish from air in different forms that may be present in other parts of the system of the present invention, such as atmospheric air 105, liquid air 109, surplus air 111, sub-ambient air 107, etc. Air 101 is further cooled to sub-ambient air 107 in cryo-recuperator 136. Sub-ambient air 107 enters air liquefier 142. Air liquefier 142 delivers liquid air 109 via liquid air feed pump 144 and an air vapor portion 157 of sub-ambient air 107 to cryo-compressor 134, while surplus air 111 discharges to atmosphere. Liquid air 109 also enters cryo-compressor 134. This combination emerges from cryo-compressor 134 as cathode intake air 105, which gains heat in cryo-recuperator 136 and then in aftercooler 140, while providing cooling of atmospheric air 101. Cathode intake air 105 continues from aftercooler 140, further increasing in temperature due, in turn, to transfer of heat in pre-heater 114 and fuel cell reaction in fuel cell generator 102.

In the fuel cell generator 102, negative oxygen ions 113, generated by reduction reaction with a ceramic cathode in cathode channel 106, pass through a solid state electrolyte 115, such as yttria stabilized zirconia. The electrolyte 115 is disposed between anode channel 104 and cathode channel 106, enabling the fuel cell generator 102 to operate with a combustible fuel, most commonly supply hydrogen 117 from fuel supply 112. Anode steam 119 and residual hydrogen 121 from anode channel 104 and oxygen depleted air 123 from cathode channel 106 then enter burner 116, producing an exhaust that includes combustion product steam 127, steam 119, and depleted air 123. This exhaust combination 119, 127, 123 expands through expander generator 108. Finally, heat of exhaust combination 119, 127, 123 is recovered, in turn, to circulating steam 125 in superheater 120 and to air 105 in pre-heater 114. Exhaust 103 discharges to atmosphere. Air 123 may be captured for further oxygen separation, as required.

In water-steam circuit 118, condensate 129 is circulated by feed pump 128 and heated, in turn, in feedwater heater 132, solar evaporator 130, and superheater 120. Steam 125, superheated above saturation, is then expanded to provide power from compressor drive 124 to liquefier compressor 138. Extraction steam 131 provides feedwater heating in heater 132. Steam 131 is also condensed into condensate 129 in condenser 126 by cooling water 133. Excess solar insolation is stored in heat storage unit 122, as required.

Innovative features of system 100 include feed of liquid air 109 into cryo-compressor 134; steam power to liquefier compressor-138 by recovered heat; and steady state fuel cell generator 102 output by load shift to compressor 138. Liquid air 109 in cryo-compressor 134 increases effectiveness of cryo-recuperator 136 by decreased terminal temperature difference, while providing least work quasi-isothermal compression of air 109, 157 in cryo-compressor 134. Steam to drive compressor 138 is generated, in turn, by evaporation in solar evaporator 130, and then superheating by recovered fuel cell exhaust heat in superheater 120. Shifting of fuel cell electric load to the air liquefier during reduced fuel cell electric demand maintains relatively constant fuel cell output to extend the fuel cell life via reduced thermal transients and associated stresses. Electric power to compressor 134 is from output of fuel cell generator 102 and expander generator 108. Supplemental electric power to compressor 134 may also be from external sources, as available and/or as needed.

The hydrogen fueled hybrid fuel cell/steam expander system exemplifies design point performance of a prime mover as shown in FIG. 1. Fuel consumption is reduced, as compared to a typical solid oxide fuel cell with heat recovery and ambient compression, due to combined effect of low cryo-compression work with heat recovery and solar evaporation. Based on 40% oxygen reacting with electrolyte and 10% unreacted residual hydrogen, the combined fuel cell and gas expander delivers 26.5 kWh/kg (12.0 kWh/lb) hydrogen with a fuel efficiency of about 80%. Operating conditions are: fuel cell pressure=10 atm. at discharge temperature=1000° C. (1832° F.), gas expander pressure ratio=10 at inlet temperature=1100° C. (2012° F.) with temperature increase due to combustion of residual hydrogen. Cryo-compressor inlet temperature is −173° C. (−280° F.). Cryo-compression reduces fuel cell compression work to about 8% of total generating capacity, as compared to 25% with ambient air at excess air ratio of 4.0. Baseline power to the liquefier compressor is from recovered heat of air expander exhaust, providing 100% liquid air for cryo-compression of working fluid in system 100. Supplemental power sources to the liquefier compressor are off-peak load shifting plus solar insolation and wind, as available. Highly variable liquid air production due to load shifting is estimated at one-third of system electric output, providing twice the liquid air for export as fuel cell baseline. Fuel consumption in motor vehicles using the export liquid air is estimated at five times higher than fuel consumption to maintain steady state fuel cell electric output. Estimated liquid air production due to solar generated steam and wind drive of the liquefier is potentially more than double as with load shifting, depending on location, collection area, tracking, and conversion efficiency.

FIG. 2 is a schematic illustrating an alternate preferred embodiment of the present invention of a fuel cell/steam expander system 200. System 200 is the preferred version of the second embodiment, discussed above. The fuel cell generator 202 generates electricity by chemical reaction. Additional electric output is generated from recovered heat of pressurized oxygen depleted air 223 discharging from cathode channel 206 at high temperature via a steam turbine generator 260. Combined electric output drives liquefaction of oxygen and air for fuel cell reaction and for export, respectively.

System 200 includes a fuel cell generator 202 with an anode channel 204 and a cathode channel 206; a cathode exhaust circulator 250 with an anode exhaust drive 252; a fuel supply 212; an air pre-heater 214; a residual hydrogen separator 254; and an oxygen mixing junction 256. System 200 also includes the following sub-systems: a cryo-oxygen/air supply 258 and a water-steam circuit 218. Cathode channel 206 provides exhaust heat to water steam circuit 218 via exchange of heat in superheater 220 following pressure drop in circulator 250. A circulator is used instead of a compressor to recirculate air back to the cathode with minimal pressure loss. Water-steam circuit 218 includes a superheater 220; a steam turbine generator 260; a condenser 226; a water feed pump 228; a solar evaporator 230; and a feedwater heater 232. Cryo-oxygen/air supply 258 includes a liquefier motor compressor 262; an aftercooler 240; an oxygen/air liquefier 264 with a liquid oxygen feed pump 266; a liquid air dewar 246; a liquid air extraction valve 248; and an external oxygen valve 268.

Composition of the fuel cell working fluid varies through system 200 downstream of atmospheric intake air 201 and supplied fuel 217. Hydrogen 217, recirculated residual hydrogen 221, and cathode intake air 205 enter fuel cell generator 202, while oxygen depleted air 223 is recirculated and anode product condensate 235 is discharged to atmosphere.

Atmospheric intake air 201 is compression heated in motor compressor 262 and then cooled to ambient in aftercooler 240, which recovers heat to evaporate liquid oxygen 237 to oxygen vapor 239. Then in oxygen/air liquefier 264, atmospheric air 201 is separated into liquid oxygen 237 that will be delivered to fuel cell generator 202 and liquid air 209 that will be stored in liquid air dewar 246 before export. Any surplus air 211 portion is discharged to atmosphere.

Oxygen 241 from an external source may be added via valve 268 and pumped into cryo-oxygen/air supply 258 through feed pump 266. Product liquid air 209 is stored for export in dewar 246 under control of valve 248. Liquid oxygen 237 from feed pump 266 is first evaporated in aftercooler 240. The evaporated oxygen 239 is then combined with oxygen depleted air 223 in mixing junction 256. This mixing forms cathode intake air 205, which is preheated by anode steam 219 and residual hydrogen 221 in pre-heater 214, before entering cathode channel 206.

In the fuel cell generator 202, negative oxygen ions 213, generated by reduction reaction with a ceramic cathode, pass through a solid state electrolyte 215, such as yttria stabilized zirconia. The electrolyte 215 is disposed between anode channel 204 and cathode channel 206, enabling the fuel cell generator 202 to operate with a combustible fuel, which is most commonly supply hydrogen 217. Finally, oxygen depleted air 223 discharging from cathode channel 206 is circulated, in turn, through superheater 220, mixing junction 256, and pre-heater 214 by circulator 250. Anode steam 219 and residual hydrogen 221 from air pre-heater 214 are provided to anode exhaust drive 252 and then to fuel separator 254. Anode exhaust drive 252 is driven by anode steam 219 and residual hydrogen fuel 221 from air-pre-heater 214. Anode exhaust drive 252 and cathode exhaust circulator 250 are in mechanical communication, so that anode steam 219 and residual hydrogen fuel 221 also indirectly drive cathode exhaust circulator 250. Anode exhaust drive 252 is in electrical communication with fuel cell generator 202, which provides electricity to anode exhaust drive 252. Fuel separator 254 is preferably a hydrogen separator that separates anode steam 219 from the residual hydrogen fuel 221. The anode steam 219 is expelled in the form of anode condensate 235 and the separated hydrogen fuel 221 is provided back to the hydrogen fuel supply 212.

In water-steam circuit 218, condensate 229, from feed pump 228, is heated in turn, in feedwater heater 232, solar evaporator 230, and superheater 220. Circulating steam 225, superheated above saturation, then expands to deliver electrical output from steam turbine generator 260. Extraction steam 231 from turbine generator 260 provides feedwater heating in heater 232 before combining with condensate 229 from condenser 226 to enter feed pump 228. Cooling water 233 provides condensation of steam 225 from turbine generator 260.

Innovative features of system 200 include recovery turbine 260 for minimal electric output within limited rotational speed; re-oxygenation of depleted air 223 while recirculating intake air 205; fuel cell heat recovery with solar evaporation; and shifting of fuel cell electric load to the liquefier motor compressor 262 during reduced fuel cell electric demand to maintain relatively constant fuel cell output to extend fuel cell life via reduced thermal transients and associated stresses.

The hydrogen fueled fuel cell/steam expander system exemplifies design point performance of a prime mover as shown in FIG. 2, capable of efficient fuel cell heat recovery as low as 2 kWe. Fuel consumption is reduced, as compared to a typical solid oxide fuel cell with heat recovery and ambient compression, due to combined effect of minimal compression work, heat recovery and solar evaporation. Exhaust recirculation is enabled by operation at minimal fuel cell inlet temperature of 350° C. (662° F). The combined fuel cell (3.0 kWe) and steam turbine (1.5 kWe) delivers 24.3 kWh/kg (11.0 kWh/lb) hydrogen with a fuel efficiency of about 75%, based on 40% oxygen reacting with electrolyte and 10% recycled residual hydrogen. Operating conditions are: fuel cell pressure=10 atm. at fuel cell discharge temperature=700° C. (1292° F.), and steam turbine pressure ratio to vacuum=50 at turbine inlet temperature=680° C. (1250° F.). Cryo-compressor inlet temperature is −173° C. (−280° F.). Fuel cell compression work is minimal because oxygen is compressed in the liquid state and recirculated air must only overcome flow resistance of recirculation at pressure. Supplemental power sources to the liquefier compressor are generated by solar insolation and wind, as available.

FIG. 3 is a schematic illustrating a further alternate preferred embodiment of the present invention of a fuel cell/gas expander system 300, in exemplary motor vehicle application. System 300 is the preferred version of the third embodiment, discussed above. Electrical output from a fuel cell generator 302 and a gas expander generator 308 provide electric drive of a vehicle. Load shifting from fuel cell generator 302 powers electric driven air liquefaction, which is supplemented by electric generation of recovered vehicle motion. The fuel cell generates electricity by chemical reaction while additional electric output is generated from pressurized fuel cell exhaust at high temperature via positive displacement expander generator 308, such as a piston engine.

System 300, includes fuel cell generator 302 with an anode channel 304 and a cathode channel 306; gas expander generator 308; a cryo-air supply 310; a primary fuel supply 312; an air pre-heater 314; a residual hydrogen burner 316; an auxiliary fuel supply 368; and an auxiliary fuel pump 370. Cryo-air supply 310 includes a cryo-compressor 334; a cryo-recuperator 336; a liquefier compressor 372 with a vehicle deceleration recovery generator 374; an aftercooler 340; and an air liquefier 342 with a liquid air feed pump 344, a liquid air dewar 346, and a liquid air extraction valve 348.

Composition of the fuel cell working fluid varies through system 300 from atmospheric intake air 301 to exhaust 303. Circulation of air, fuel, and products of reaction is described, as follows. Intake air 301 is compression heated in compressor 372 and then cooled to ambient in aftercooler 340, which recovers heat to pre-heat cathode intake air 305. Air 301 is further cooled to sub-ambient air 307 in cryo-recuperator 336. Sub-ambient air 307 enters air liquefier 342. Air liquefier 342 delivers liquid air 309 via liquid air feed pump 344 and an air vapor portion 357 of sub-ambient air 307 to cryo-compressor 334. Surplus air 311 discharges to atmosphere. Liquid air 309 also enters cryo-compressor 334. This combination emerges as cathode intake air 305, which gains heat in cryo-recuperator 336 and then in aftercooler 340, while providing cooling of intake air 301. Air 305 continues from aftercooler 340, further increasing in temperature due, in turn, to transfer of heat in pre-heater 314 and fuel cell reaction in fuel cell generator 302.

In the fuel cell, negative oxygen ions 313, generated by reduction reaction with a ceramic cathode, pass through a solid state electrolyte 315, such as yttria stabilized zirconia. The electrolyte 315 is disposed between anode channel 304 and cathode channel 306, enabling the fuel cell generator 302 to operate with a combustible fuel, such as supply hydrogen 317. Anode steam 319 and residual hydrogen 321 from anode channel 304 and oxygen depleted air 323 from cathode channel 306 then combine in burner 316 with auxiliary fuel 355 from auxiliary fuel supply 368 via auxiliary fuel pump 370. Auxiliary fuel 355 is preferably a carbon free fuel, such as hydrogen peroxide or ammonia. Exhaust, including combustion product steam 327, steam 319, and depleted air 323 from burner 316, expands through expander-generator 308. Heat of exhaust combination 319, 323, 327 is recovered to air 305 in pre-heater 314 as exhaust 303 discharges to atmosphere.

Innovative features of system 300 include feed of liquid air 309 into cryo-compressor 334; electric drive of liquefier compressor 372 by load shift of fuel cell generator 302 plus recovered energy of vehicle motion; and provision of auxiliary fuel 355. Liquid air 309 in cryo-compressor 334 increases effectiveness of cryo-recuperator 336 by decreased terminal temperature difference, while providing least work quasi-isothermal compression of air 309, 357 in cryo-compressor 334. Shifting of fuel cell electric load to the liquefier motor compressor 372 during reduced fuel cell electric demand maintains relatively constant fuel cell output to extend fuel cell life via reduced thermal transients and associated stresses. Supplemental electric power to compressor 372 is from output of fuel cell generator 302 and expander-generator 308, shown in arrowed lines between these components. Auxiliary fuel 355 is provided to minimize required hydrogen storage volume with a non-carbon liquid fuel.

The hydrogen fueled hybrid fuel cell/gas expander system exemplifies design point performance of a prime mover as shown in FIG. 3. Fuel consumption is reduced, as compared to a typical solid oxide fuel cell with heat recovery and ambient compression, due to the effect of low cryo-compression work with heat recovery. Based on 40% oxygen reacting with electrolyte and 10% unreacted residual hydrogen, the combined fuel cell and gas expander delivers 26.5 kWh/kg (12.0 kWh/lb) hydrogen with a fuel efficiency of about 65%. Operating conditions are: fuel cell pressure=10 atm. at discharge temperature=700° C. (1292° F.), gas expander pressure ratio=10 at inlet temperature=750° C. (1382° F.) with temperature increase due to combustion of residual hydrogen and auxiliary fuel. The auxiliary fuel is preferably carbon free, such as ammonia, hydrazine, or hydrogen peroxide to avoid discharge of carbon dioxide to atmosphere. Cryo-compressor inlet temperature is −173° C. (−280° F.). Cryo-compression reduces fuel cell compression work to about 10% of total generating capacity, as compared to 25% with ambient air at excess air ratio of 2.5. Baseline power to the liquefier compressor is from load shifting during vehicle coasting with supplemental power from energy of recovered vehicle motion, providing 100% liquid air for cryo-compression of working fluid in system 300. Highly variable liquid air production due to load shifting vehicle deceleration recovery is estimated at one-half of system electric output, providing twice the liquid air for export as fuel cell baseline. Fuel consumption in motor vehicles using the export liquid air is estimated at 5 times higher than fuel consumption to maintain steady state fuel cell electric output

A solid oxide fuel cell for hybrid arrangement with expansion engines is available from Mitsubishi Hitachi Power Systems of Yokahama, Japan. Several major motor vehicle manufacturers have advanced development programs for fuel cell expander hybrids. Several types of positive displacement expanders, and expansion cooled air liquefiers and solar heaters are commercially available in a wide range of sizes. Other components, including heat exchangers (superheaters, aftercoolers), valves, compressors, and turbines are available “off the shelf” to meet the full range of size requirements.

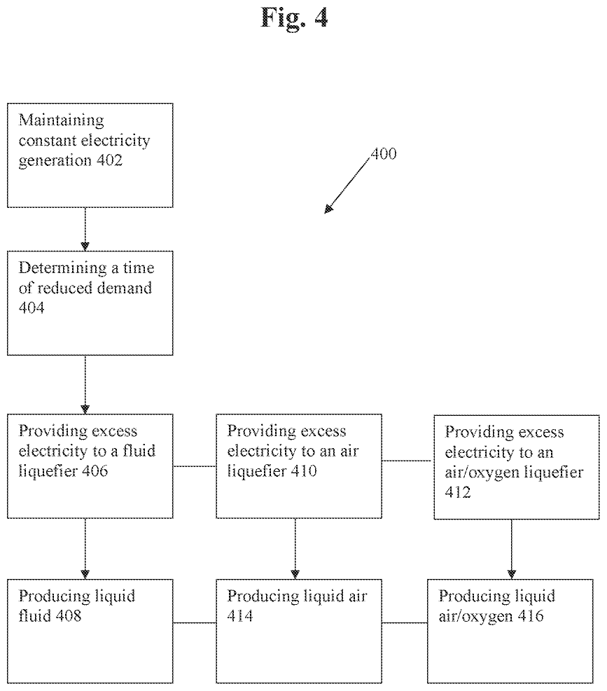

Now referring to FIG. 4, steps of method 400 for operating a fuel cell system with co-generation means of the present invention are provided. Method 400 includes the steps of maintaining constant electricity generation in a fuel cell for an application requiring electricity 402; determining a time of reduced demand for the electricity generated in the generating step 404; providing excess generated electricity during the time of reduced demand to a fluid liquefier 406; and producing liquid fluid 408. The providing step may be providing excess generated electricity during the time of reduced demand to an air liquefier 410 or providing excess generated electricity during the time of reduced demand to an air/oxygen liquefier 412. Providing step 410 results in producing liquid air 414. Providing step 412 results in producing liquid air/oxygen 416.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

1. A fuel cell generator with cryogenic compression and co-generation of liquefied fluid, comprising:
a liquefier compressor that compression heats atmospheric air to heated air;
an aftercooler in fluid communication with said liquefier compressor such that said liquefier compressor provides the heated air to said aftercooler and wherein said aftercooler cools the heated air to ambient air;
a cryo-fluid supply, comprising:
a fluid liquefier in fluid communication with said aftercooler such that said aftercooler provides the ambient air to said fluid liquefier and wherein said fluid liquefier liquefies at least a first portion of the ambient air into liquid fluid;
a liquid fluid dewar in fluid communication with said fluid liquefier such that said fluid liquefier provides at least a first portion of the liquid fluid to said liquid fluid dewar and wherein said liquid fluid dewar stores at least the first portion of the liquid fluid; and
a liquid fluid feed pump in fluid communication with said fluid liquefier and said aftercooler such that said fluid liquefier provides at least a second portion of the liquid fluid to said liquid fluid feed pump and said liquid fluid feed pump pumps at least the second portion of the liquid fluid to said aftercooler;
an air pre-heater in fluid communication with said aftercooler such that said aftercooler provides said air pre-heater with cathode intake air and wherein said air pre-heater heats the cathode intake air;
a fuel cell generator that generates electricity through chemical reaction, said fuel cell generator comprising:
a cathode channel where a cathode reduction reaction occurs and that produces negative oxygen ions, wherein said cathode channel expels oxygen depleted air;
an anode channel where an anode oxidation reaction occurs;
a solid state electrolyte disposed between said cathode channel and said anode channel, wherein the negative oxygen ions from said cathode channel pass through said solid state electrolyte; and
a fuel supply that provides a fuel to said anode channel, wherein said anode channel expels anode steam and residual fuel;
wherein said air pre-heater is in further fluid communication with said cathode channel such that said air pre-heater provides the heated cathode intake air to said cathode channel; and
means for driving said liquefier compressor.

2. The cryo-compression fuel cell generator as claimed in claim 1, wherein said means comprise a water-steam circuit comprising:
a driver that drives said liquefier compressor and expels extraction steam and circulating steam;
a condenser in fluid communication with said driver such that said driver provides the circulating steam to said condenser and wherein said condenser condenses the circulating steam into condensate;
a water feed pump in fluid communication with said condenser such that said condenser provides the condensate to said water feed pump;
a feedwater heater in fluid communication with said driver such that said driver provides the extraction steam to said feedwater heater and in fluid communication with said water feed pump such that said water feed pump pumps the condensate to said feedwater heater, wherein said feedwater heater uses heat from the extraction steam to heat the condensate;
a solar evaporator in fluid communication with said feed water heater such that said feedwater heater provides the heated condensate to said solar evaporator and wherein said solar evaporator uses solar radiation to heat the condensate into the circulating steam;
a superheater in fluid communication with said solar evaporator such that said solar evaporator provides the circulating steam to said superheater, wherein:
said superheater heats the circulating steam; and
said superheater is in fluid communication with said driver such that said superheater provides said driver with the heated circulating steam and the driver is driven by the heated circulating steam.

3. The cryo-compression fuel cell generator as claimed in claim 2, wherein:
said driver is a hybrid expander electric compressor drive; and
said hybrid expander-electric compressor drive is in mechanical communication with said liquefier compressor such that said hybrid expander-electric compressor drive drives said liquefier compressor.

4. The cryo-compression fuel cell generator as claimed in claim 3, further comprising a heat storage unit that stores excess solar insolation.

5. The cryo-compression fuel cell generator as claimed in claim 2, wherein:
said driver is a steam turbine generator that generates electricity from the circulating steam; and
said steam turbine generator is in electrical communication with said liquefier compressor such that said steam turbine generator drives said liquefier compressor by electricity.

6. The cryo-compression fuel cell generator as claimed in claim 5, wherein said fuel cell generator is also in electrical communication with said liquefier compressor such that said fuel cell generator drives said liquefier compressor by electricity.

7. The cryo-compression fuel cell generator with cryogenic compression and co-generation of liquefied fluid as claimed in claim 1, wherein said means comprise external electricity.

8. The cryo-compression fuel cell generator as claimed in claim 1, wherein:
said cryo-fluid supply is a cryo-air supply and the liquid fluid is liquid air such that:
said fluid liquefier is an air liquefier;
said liquid fluid dewar is a liquid air dewar;
said liquid fluid feed pump is a liquid air feed pump;
said cryo-air supply further comprises a cryo-recuperator, wherein:
said cryo-recuperator is in fluid communication with said aftercooler such that said aftercooler provides the ambient air to said cryo-recuperator;
said cryo-recuperator further cools the ambient air to sub-ambient air;
said cryo-recuperator is in fluid communication with said air liquefier; and
said aftercooler provides the ambient air to said air liquefier through said cryo-recuperator such that the ambient air is sub-ambient air;
said cryo-air supply further comprises a cryo-compressor, wherein:
said cryo-compressor is in fluid communication with said air liquefier such that said air liquefier provides an air vapor portion of the sub-ambient air to said cryo-compressor;
said cryo-compressor is in fluid communication with said cryo-recuperator such that said cryo-recuperator provides said cryo-compressor with at least a second portion of the sub-ambient air;
said cryo-compressor compression heats a combination of the at least second portion of the liquid air and the at least second portion of sub-ambient air into the cathode intake air;
said cryo-compressor is in further fluid communication with said cryo-recuperator such that said cryo-compressor provides the cathode intake air to said cryo-recuperator;
said cryo-recuperator heats the cathode intake air;
said cryo-recuperator is in further fluid communication with said aftercooler such that said cryo-recuperator provides the heated cathode intake air to said aftercooler; and
said fuel cell generator is in electrical communication with said cryo-compressor such that said fuel cell generator provides electricity to said cryo-compressor.

9. The cryo-compression fuel cell generator as claimed in claim 1, wherein:
said cryo-fluid supply is a cryo-oxygen/air supply and the liquid fluid is liquid oxygen and liquid air such that:
said fluid liquefier is an oxygen/air liquefier;
said liquid fluid dewar is a liquid air dewar;
said liquid fluid feed pump is a liquid oxygen feed pump; and
said aftercooler evaporates the liquid oxygen into oxygen vapor.

10. The cryo-compression fuel cell generator with cryogenic compression and co-generation of liquefied fluid as claimed in claim 1, wherein the fuel of said fuel supply is hydrogen.

11. The cryo-compression fuel cell generator as claimed in claim 1, wherein said means comprise a vehicle deceleration recovery generator in electrical communication with said liquefier compressor such that said vehicle deceleration recovery generator provides electricity to said liquefier compressor.

12. The cryo-compression fuel cell generator as claimed in claim 8, further comprising:
a burner, wherein said burner:
is in fluid communication with said anode channel such that said anode channel provides the anode steam and residual fuel to said burner,
is in fluid communication with said cathode channel such that said cathode channel provides oxygen depleted air to said burner; and
burns the residual fuel into combustion product steam; and
a gas expander generator that generates electricity from steam and air, wherein said gas expander generator is in:
fluid communication with said burner such that said burner provides the anode steam, combustion product steam, and oxygen depleted air to said gas expander generator; and
electrical communication with said cryo-compressor of said cryo-air supply such that said gas expander generator provides said cryo-compressor with electricity.

13. The cryo-compression fuel cell generator as claimed in claim 12, wherein said gas expander generator is in further electrical communication with said liquefier compressor such that said gas expander generator provides said liquefier compressor with electricity, such that said gas expander generator is said means.

14. The cryo-compression fuel cell generator as claimed in claim 13, wherein said means further comprise a vehicle deceleration recovery generator in electrical communication with said liquefier compressor such that said vehicle deceleration recovery generator provides electricity to said liquefier compressor.

15. The cryo-compression fuel cell generator with cryogenic compression and co-generation of liquefied fluid as claimed in claim 1, wherein said fuel cell generator is in electrical communication with said liquefier compressor such that said fuel cell generator drives said liquefier compressor by electricity.

16. The cryo-compression fuel cell generator as claimed in claim 13, further comprising an auxiliary fuel supply in fluid communication with said burner such that said auxiliary fuel supply provides auxiliary fuel to said burner burns the auxiliary fuel to produce additional combustion product steam.

17. The cryo-compression fuel cell generator as claimed in claim 16, wherein the auxiliary fuel is a non-carbon liquid fuel.

18. The cryo-compression fuel cell generator as claimed in claim 12, wherein said gas expander generator is in further fluid communication with said air pre-heater such that said gas expander generator provides the anode steam, the combustion product steam, and the oxygen depleted air to said air pre-heater.

19. The cryo-compression fuel cell generator with cryogenic compression and co-generation of liquefied fluid as claimed in claim 1, wherein said solid state electrolyte is yttria stabilized zirconia.

20. The cryo-compression fuel cell generator as claimed in claim 3, wherein:
said cryo-fluid supply is a cryo-air supply and the liquid fluid is liquid air such that:
said fluid liquefier is an air liquefier;
said liquid fluid dewar is a liquid air dewar;
said liquid fluid pump is a liquid air feed pump;
said cryo-air supply further comprises a cryo-recuperator, wherein:
said cryo-recuperator is in fluid communication with said aftercooler such that said aftercooler provides the ambient air to said cryo-recuperator;
said cryo-recuperator further cools the ambient air to sub-ambient air;
said cryo-recuperator is in fluid communication with said air liquefier; and
said aftercooler provides the ambient air to said air liquefier through said cryo-recuperator such that the ambient air is sub-ambient air;
said cryo-air supply further comprises a cryo-compressor, wherein:
said cryo-compressor is in fluid communication with said air liquefier such that said air liquefier provides an air vapor portion of the sub-ambient air to said cryo-compressor;
said cryo-compressor is in fluid communication with said cryo-recuperator such that said cryo-recuperator provides said cryo-compressor with at least a second portion of sub-ambient air;
said cryo-compressor compression heats a combination of the at least second portion of the liquid air and the at least second portion of sub-ambient air into the cathode intake air;
said cryo-compressor is in further fluid communication with said cryo-recuperator such that said cryo-compressor provides the cathode intake air to said cryo-recuperator;
said cryo-recuperator heats the cathode intake air;
said cryo-recuperator is in further fluid communication with said aftercooler such that said cryo-recuperator provides the heated cathode intake air to said aftercooler; and
said fuel cell generator is in electrical communication with said cryo-compressor such that said fuel cell generator provides electricity to said cryo-compressor;
said cryo-compression fuel cell with expansion engine further comprises:
a burner, wherein said burner:
is in fluid communication with said anode channel such that said anode channel provides the anode steam and residual fuel to said burner;
is in fluid communication with said cathode channel such that said cathode channel provides oxygen depleted air to said burner; and
burns the residual fuel into combustion product steam; and
a gas expander generator that generates electricity from steam and air, wherein said gas expander generator is in:
fluid communication with said burner such that said burner provides at least a first portion of the anode steam, the combustion product steam, and the oxygen depleted air to said gas expander generator;
fluid communication with said superheater of said water-steam circuit such that said gas expander generator provides the anode steam, the combustion product steam, and the oxygen depleted air to said superheater; and
electrical communication with said cryo-compressor such that said gas expander generator provides said cryo-compressor with electricity.

21. The cryo-compression fuel cell generator as claimed in claim 9, wherein:
said anode channel is in further fluid communication with said air pre-heater such that said anode channel provides the anode steam and the residual fuel to said air pre-heater; and
said cryo-compression fuel cell generator further comprises:
a cathode exhaust circulator in fluid communication with said cathode channel of said fuel cell generator such that said cathode channel provides the oxygen depleted air to said cathode exhaust circulator and wherein said cathode exhaust circulator circulates the oxygen depleted air;
an anode exhaust drive in fluid communication with said air pre-heater such that said air pre-heater provides the anode steam and the residual fuel to said anode exhaust drive and wherein said anode exhaust drive condenses the anode steam into anode condensate; and
a fuel separator in fluid communication with said anode exhaust drive such that said anode exhaust drive provides the anode condensate and residual fuel to said fuel separator, wherein:
said fuel separator separates the anode condensate from the residual fuel;
said fuel separator is in fluid communication with said fuel supply of said fuel cell generator such that said fuel separator provides the residual fuel to said fuel supply;
said fuel separator expels the anode condensate; and
said fuel supply further supplies the residual fuel to said anode channel.

22. The cryo-compression fuel cell generator as claimed in claim 21, wherein:
said means comprise a water-steam circuit comprising:
a steam turbine generator that drives said liquefier compressor, expels extraction steam and circulating steam, and generates electricity from the circulating steam;
a condenser in fluid communication with said driver such that said steam turbine generator provides the circulating steam to said condenser and wherein said condenser condenses the circulating steam into condensate;
a water feed pump in fluid communication with said condenser such that said condenser provides the condensate to said water feed pump;
a feedwater heater in fluid communication with said steam turbine generator such that said steam turbine generator provides the extraction steam to said feedwater heater and in fluid communication with said water feed pump such that said water feed pump pumps the condensate to said feedwater heater, wherein said feedwater heater uses heat from the extraction steam to heat the condensate;
a solar evaporator in fluid communication with said feedwater heater such that said feedwater heater provides the heated condensate to said solar evaporator and wherein said solar evaporator uses solar radiation to heat the condensate into the circulating steam;
a superheater in fluid communication with said solar evaporator such that said solar evaporator provides the circulating steam to said superheater, wherein:
said superheater heats the circulating steam; and
said superheater is in fluid communication with said steam turbine generator such that said superheater provides said steam turbine generator with the heated circulating steam and said steam turbine generator is driven by the heated circulating steam;
wherein said steam turbine generator is in electrical communication with said liquefier compressor such that said steam turbine generator drives said liquefier compressor by electricity;
said cathode exhaust circulator is in further fluid communication with said superheater of said water-steam circuit such that said cathode exhaust circulator provides oxygen depleted air to said superheater; and
said cryo-compression fuel cell generator further comprises an oxygen mixing junction, in fluid communication with:
said superheater such that said superheater provides oxygen depleted air to said oxygen mixing junction;
said aftercooler such that said aftercooler provides the oxygen vapor to said oxygen mixing junction, wherein said oxygen mixing junction mixes the oxygen depleted air and the oxygen vapor to create cathode intake air; and said air pre-heater such that said aftercooler provides said air pre-heater with cathode intake air through said oxygen mixing junction.

23. A method for operating a fuel cell system with co-generation means, said method comprising the steps of:
maintaining constant electricity generation in the fuel cell;
determining a time of reduced demand for the electricity generated in said maintaining step;
providing excess generated electricity generated in said maintaining step during the time of reduced demand determined in said determining step to a fluid liquefier; and
producing liquid fluid.

24. The method as claimed in claim 23, wherein:
said step of providing excess generated electricity generated in said maintaining step during the time of reduced demand determined in said determining step to a fluid liquefier comprises providing excess generated electricity generated in said maintaining step during the time of reduced demand determined in said determining step to an air liquefier; and
said step of producing liquid fluid comprises producing liquid air.

25. The method as claimed in claim 23, wherein:
said step of providing excess generated electricity generated in said maintaining step during the time of reduced demand determined in said determining step to a fluid liquefier comprises providing excess generated electricity generated in said maintaining step during the time of reduced demand determined in said determining step to an air/oxygen liquefier; and
said step of producing liquid fluid comprises producing liquid air/oxygen.

26. The cryo-compression fuel cell generator as claimed in claim 7, wherein said means further comprise a water-steam circuit comprising:
driver that drives said liquefier compressor and expels extraction steam and circulating steam;
a condenser in fluid communication with said driver such that said driver provides the circulating steam to said condenser and wherein said condenser condenses the circulating steam into condensate;
a water feed pump in fluid communication with said condenser such that said condenser provides the condensate to said water feed pump;
a feedwater heater in fluid communication with said driver such that said driver provides the extraction steam to said feedwater heater and in fluid communication with said water feed pump such that said water feed pump pumps the condensate to said feedwater heater, wherein said feedwater heater uses heat from the extraction steam to heat the condensate;
a solar evaporator in fluid communication with said feedwater heater such that said feedwater heater provides the heated condensate to said solar evaporator and wherein said solar evaporator uses solar radiation to heat the condensate into the circulating steam;
a superheater in fluid communication with said solar evaporator such that said solar evaporator provides the circulating steam to said superheater, wherein:
said superheater heats the circulating steam; and
said superheater is in fluid communication with said driver such that said superheater provides said driver with the heated circulating steam and the driver is driven by the heated circulating steam.

27. The cryo-compression fuel cell generator as claimed in claim 26, wherein:
said driver is a hybrid expander electric compressor drive; and
said hybrid expander-electric compressor drive is in mechanical communication with said liquefier compressor such that said hybrid expander-electric compressor drive drives said liquefier compressor.

28. The cryo-compression fuel cell generator as claimed in claim 27, further comprising a heat storage unit that stores excess solar insolation.

29. The cryo-compression fuel cell generator as claimed in claim 26, wherein:
said driver is a steam turbine generator that generates electricity from the circulating steam; and
said steam turbine generator is in electrical communication with said liquefier compressor such that said steam turbine generator drives said liquefier compressor by electricity.

30. The cryo-compression fuel cell generator as claimed in claim 29, wherein said fuel cell generator is also in electrical communication with said liquefier compressor such that said fuel cell generator drives said liquefier compressor by electricity.

31. The cryo-compression fuel cell generator as claimed in claim 7, wherein:
said cryo-fluid supply is a cryo-air supply and the liquid fluid is liquid air such that:
said fluid liquefier is an air liquefier;
said liquid fluid dewar is a liquid air dewar;
said liquid fluid feed pump is a liquid air feed pump;
said cryo-air supply further comprises a cryo-recuperator, wherein:
said cryo-recuperator is in fluid communication with said aftercooler such that said aftercooler provides the ambient air to said cryo-recuperator;
said aftercooler provides the ambient air to said cryo-recuperator;
said cryo-recuperator further cools the ambient air to sub-ambient air;
said cryo-recuperator is in fluid communication with said air liquefier; and
said aftercooler provides the ambient air to said air liquefier through said cryo-recuperator such that the ambient air is sub-ambient air;
said cryo-air supply further comprises a cryo-compressor, wherein:
said cryo-compressor is in fluid communication with said air liquefier such that said air liquefier provides an air vapor portion of the sub-ambient air to said cryo-compressor;
said cryo-compressor is in fluid communication with said cryo-recuperator such that said cryo-recuperator provides said cryo-compressor with at least a second portion of the sub-ambient air;
said cryo-compressor compression heats a combination of the at least second portion of the liquid air and the at least second portion of sub-ambient air into the cathode intake air;
said cryo-compressor is in further fluid communication with said cryo-recuperator such that said cryo-compressor provides the cathode intake air to said cryo-recuperator;
said cryo-recuperator heats the cathode intake air;
said cryo-recuperator is in further fluid communication with said aftercooler such that said cryo-recuperator provides the heated cathode intake air to said aftercooler; and
said fuel cell generator is in electrical communication with said cryo-compressor such that said fuel cell generator provides electricity to said cryo-compressor.

32. The cryo-compression fuel cell generator as claimed in claim 31, further comprising:
a burner, wherein said burner:
is in fluid communication with said anode channel such that said anode channel provides the anode steam and residual fuel to said burner;
is in fluid communication with said cathode channel such that said cathode channel provides oxygen depleted air to said burner; and
burns the residual fuel into combustion product steam; and
a gas expander generator that generates electricity from steam and air, wherein said gas expander generator is in:
fluid communication with said burner such that said burner provides the anode steam, combustion product steam, and oxygen depleted air to said gas expander generator; and
electrical communication with said cryo-compressor of said cryo-air supply such that said gas expander generator provides said cryo-compressor with electricity.

33. the cryo-compression fuel cell generator as claimed in claim 32, wherein said gas expander generator is in further electrical communication with said liquefier compressor such that said gas expander generator provides said liquefier compressor with electricity, such that said gas expander generator is also said means.

34. The cryo-compression fuel cell generator as claimed in claim 33, wherein said means further comprise a vehicle deceleration recovery generator in electrical communication with said liquefier compressor such that said vehicle decleration recovery generator provides electricity to said liquefier compressor.

35. The cryo-compression fuel cell generator as claimed in claim 33, further comprising an auxiliary fuel supply in fluid communication with said burner such that said auxiliary fuel supply provides auxiliary fuel to said burner burns the auxiliary fuel to produce additional combustion product steam.

36. The cryo-compression fuel cell generator as claimed in claim 35, wherein the auxiliary fuel is a non-carbon liquid fuel.

37. The cryo-compression fuel cell generator as claimed in claim 32, wherein said gas expander generator is in further fluid communication with said air pre-heater such that said gas expander generator provides the anode steam, the combustion product steam, and the oxygen depleted air to said air pre-heater.

38. The cryo-compression fuel cell generator with cryogenic compression and co-generation of liquefied fluid as claimed in claim 1, wherein load shifting via electrical communication occurs from said fuel cell generator to said liquefier compressor.
